(19) United States
(12) Patent Application Publication
(10) Pub. No.: US 2016/0215966 A1
(43) Pub. Date: Jul. 28, 2016

(54) PORTABLE VANITY LIGHTING SYSTEM

(71) Applicant: MCKENN ENTERPRISES INC., Toronto (CA)

(72) Inventors: Philip Heller, Toronto (CA); Robert G. Dickie, King City (CA)

(21) Appl. No.: 14/915,535

(22) PCT Filed: Aug. 28, 2014
(86) PCT No.: PCT/CA2014/050821

§ 371 Date: Feb. 29, 2016

(30) Foreign Application Priority Data
Aug. 30, 2013 (CA) 2825559

(51) Int. Cl. F21V 21/30; F21V 21/08; F21V 21/14; F21L 4/08; F21V 21/092

(52) U.S. Cl. CPC F21V 21/30; F21L 4/08; F21V 21/0925; F21V 21/145; F21V 21/0808; F21Y 2101/02

(57) ABSTRACT

A portable vanity lighting system has a plurality of segments comprising at least a first pair of first and second segments, the front face of each segment is provided with at least one illuminating member. The segments of each pair of segments are hingedly connected together and have securing members and recesses wherein the securing members and recesses are arranged such that the securing members are received in the recesses when the segments are moved to a closed position.

### CROSS REFERENCE TO RELATED APPLICATIONS

This application claims priority from Canadian patent application 2,825,559 filed on Aug. 30, 2013.

### FIELD

This specification relates to portable vanity lighting systems.

### INTRODUCTION

Typically, a vanity light is positioned on or about a mirrored surface to provide illumination to, e.g. a user's face or body for the application of make-up, clothing and the like. Various types of vanity lighting apparatus are known. For example, U.S. Pat. No. 7,484,878 discloses a vanity lighting apparatus comprising a plurality of individual straight sections some of which have electrical connectors that can be plugged into another section.

### SUMMARY

In one aspect of this disclosure, a portable vanity lighting system is provided wherein which is adapted for travel. A vanity lighting system maybe packed in a suitcase or hand luggage during travel. Both hand luggage and suitcases are subjected to impacts during travel and the contents therein may be damaged. In accordance with this aspect, the portable vanity lighting system is designed as a plurality of segments that are hingedly connected together so that they may be folded to overlie each other. The segments may have the illuminating members (e.g., LEDs) recessed therein or recess into an overlying section when in the closed position. Alternately, or in addition, the segments may have securing members (e.g., releasable adhesive members, suction cups) recess into an overlying section when in the closed position. One advantage of this design is that the portable vanity lighting system is less prone to being damaged during transport as the sections, in their folded or closed position, may abut each other. Further, the segments are secured to each other and will not be separated from each other during travel.

In accordance with this aspect there is provided a portable vanity lighting system comprising:
a plurality of segments comprising at least a first pair of first and second segments
   (a) each segment having a front face, a rear face, and first and second laterally spaced apart opposed ends,
   (b) the front face of each segment is provided with at least one illuminating member, and
   (c) in each pair of segment
      (i) collectively, the rear faces of the first and second segments includes at least one securing device and at least one recess,
      (ii) the first segment is hingedly connected to the second segment and is moveable between an open position and a closed position, and
      (iii) in the closed position the rear face of the first segment overlies the rear face of the second segment, and each of the at least one securing device is received in one of the at least one recess.

In some embodiments, in each pair of segments, the first and second segments may be arranged in an arc when in the open position.

In some embodiments, the plurality of segments may further comprise a second pair of first and second segments, and the second pair of segments may be electrically connected to the first pair of segments.

In some embodiments, the second pair of segments may be positionable at a selective distance from the first pair of segments.

In some embodiments, the plurality of segments may further comprise at least one additional segment and each additional segment may be hingedly connected to one of the first and second segments of one of the pair of segments.

In some embodiments, when in the open position, the illuminating members of the plurality of segments may provide illumination to illuminate a left side, a right side and a center portion of a face positioned in front of the portable vanity lighting system.

In some embodiments, the at least one securing device of each pair of segments may include at least one adhesive member.

In some embodiments, the at least one securing device of each pair of segments may include at least one suction cup.

In some embodiments, the at least one of the segments may comprise a battery compartment.

In some embodiments, the at least one of the segments of the first pair may comprise a battery compartment and the second pair of segments may be electrically connected to the battery compartment.

In some embodiments, the battery compartment may be electrically connectable to an external power source for recharging at least one rechargeable battery which is receivable in the battery compartment.

In some embodiments, in each pair of segments, the first segment may be electrically connected to the second segment.

In some embodiments, the illuminating members may be recessed in the segments.

In some embodiments, the illuminating members may comprise LEDs.

In some embodiments, the portable vanity lighting system may further comprise a controller configured to dim the light output of the illuminating members of at least one of the plurality of segments in response to a signal from an actuator.

In some embodiments, the second pair of segments may be electrically connected to the first pair of segments by a flexible electrical cable.

In some embodiments, each of the plurality of segments may include an actuator for selectively controlling illumination of the illuminating members of that segment.

In some embodiments, one of the pluralities of segments may include an actuator for selectively controlling illumination of the illuminating members of the plurality of segments.

In some embodiments, each of the rear faces of the first and second segments may include a plurality of securing devices and a plurality of recesses.

In some embodiments, in the closed position, each of the plurality of securing devices may be received in a different one of the plurality of recesses.

In some embodiments, the first and second segments of each pair of segments may be arranged in an arc when in the open position, and the first and second pairs of segments may be positionable to form opposing arcs of a common circle.

In accordance with another aspect, there is provided a portable vanity lighting system including a plurality of segments including at least a center segment, a left segment and a right segment. Each segment may have a front face that is provided with at least one illuminating member, a rear face and first and second laterally spaced apart opposed ends. The left segment may be hingedly connected to the first end of the center segment and moveable to a closed position in which the left segment overlies one of the front and rear faces of the center segment. The right segment may be hingedly connected to the second end of the center segment and moveable to a closed position in which the right segment overlies the other of the one of the front and rear faces of the center segment.

In some embodiments, the left, center and right segments may be arranged in an arc when in an open position.

In some embodiments, when in an open position, the illuminating members may provide illumination to illuminate a left side, a right side and a center portion of a face positioned in front of the portable vanity lighting system.

In some embodiments, the illuminating members may be recessed in the segments.

In some embodiments, each segment may include a plurality of illuminating members.

In some embodiments, the illuminating members may include LEDs.

In some embodiments, the portable vanity lighting system may further include a securing device on the rear face of the segment which may overlie the rear face of the center segment when in the closed position and the center segment may have a recess for receiving the securing device.

In some embodiments, the securing device may include a suction cup.

In some embodiments, the securing device may include adhesive members.

In some embodiments, the portable vanity lighting system may further include rechargeable batteries.

In another aspect, there is a portable vanity lighting system. The portable vanity lighting system includes a plurality of segments, each segment having a front face that may be provided with at least one illuminating member, a rear face and first and second spaced apart opposed ends. The segments may be hingedly connected together about a pivot axis that extends in a plane that is parallel to the front face of the segments. The segments may be moveable to an open position wherein the segments are positioned side by side with the front faces in the same plane and a closed position in which the segments overlie each other.

In some embodiments, the plurality of segments may include at least a center segment, a left segment and a right segment, wherein, in the closed position, one of the right and left segments may overlie the front face of the center section and the other of the right and left segments may overlie the rear face of the center section.

In some embodiments, the segments may be arranged in an arc when in an open position.

In some embodiments, when in an open position, the illuminating members may provide illumination to illuminate a left side, a right side and a center portion of a face positioned in front of the portable vanity lighting system.

In some embodiments, the illuminating members may be recessed in the segments.

In some embodiments, each segment may include a plurality of illuminating members.

In some embodiments, the illuminating members may include LEDs.

In some embodiments, the portable vanity lighting system may further include a securing device on the rear face of the segment which overlies the rear face of the center segment when in the closed position and the center segment may have a recess for receiving the securing device.

In some embodiments, the securing device may include a suction cup.

In some embodiments, the securing device may include adhesive members.

In some embodiments, the portable vanity lighting system may further include rechargeable batteries.

In some embodiments, the portable vanity lighting system may further include a controller configured to dim the light output of the at least one illuminating member of at least one of the plurality of segments in response to a signal from an actuator

### DRAWINGS

The drawings included herewith are for illustrating various examples of articles, methods, and apparatuses of the teaching of the present specification and are not intended to limit the scope of what is taught in any way.

FIG. 1 shows a perspective view of a portable vanity lighting system in an open position, in accordance with at least one embodiment;

FIG. 2 shows a front elevation view of the portable vanity lighting system of FIG. 1;

FIG. 3 shows a bottom plan view of the portable vanity lighting system of FIG. 1;

FIG. 4, shows another perspective view of the portable vanity lighting system of FIG. 1;

FIG. 5 shows a front perspective view of the portable vanity lighting system of FIG. 1 with the left and right segments partially folded;

FIG. 6 shows a rear perspective view of the portable vanity lighting system of FIG. 1 in the configuration of FIG. 5;

FIG. 7 shows a perspective view of the portable vanity lighting system of FIG. 1, with the left and right segments in a closed position;

FIG. 8 shows a perspective view of the portable vanity lighting system of FIG. 1 in a first rotational position and positioned in front of a user's face;

FIG. 9 shows a top plan view of the portable vanity lighting system of FIG. 1 in the first rotational position and positioned in front of a user's face;

FIG. 10 shows a side elevation view of the portable vanity lighting system of FIG. 1 in the first rotational position and positioned in front of a user's face;

FIG. 11 shows a perspective view of the portable vanity lighting system of FIG. 1 in a second rotational position and positioned in front of a user's face;

FIG. 12 shows a side elevation view of the portable vanity lighting system of FIG. 1 in the second rotational position and positioned in front of a user's face;

FIG. 13 shows a rear elevation view of the portable vanity lighting system of FIG. 1 in the first rotational position and positioned in front of a user's face;

FIG. 14 shows a rear elevation view of the portable vanity lighting system of FIG. 1 in the second rotational position and positioned in front of a user's face;

FIG. 15 shows a front perspective view of a portable vanity lighting system in an open position, in accordance with another embodiment;

FIG. 16 shows a front elevation view of the portable vanity lighting system of FIG. 15;

FIG. 17 shows a top plan view of the portable vanity lighting system of FIG. 15;

FIG. 18 shows a rear perspective view of the portable vanity lighting system of FIG. 15;

FIG. 19 shows a front perspective view of a segment group of the portable vanity lighting system of FIG. 15, in accordance with at least one embodiment;

FIG. 20 shows a rear perspective view of the segment group of FIG. 19;

FIG. 21 shows a front perspective view of the segment group of FIG. 19 in a closed position;

FIG. 22 shows a front perspective view of the portable vanity lighting system of FIG. 15 in a first rotational position, positioned in front of a user's face, and connected with a power cord;

FIG. 23 shows a front perspective view of the portable vanity lighting system of FIG. 15 in the first rotational position, positioned in front of the user's face, and disconnected from the power cord;

FIG. 24 shows a front perspective view of the portable vanity lighting system of FIG. 15 in the first rotational position, and positioned in front of the user's face;

FIG. 25 shows a top plan view of the portable vanity lighting system of FIG. 15 in the first rotational position, and positioned in front of the user's face;

FIG. 26 shows a side elevation view of the portable vanity lighting system of FIG. 15 in the first rotational position, and positioned in front of the user's face;

FIG. 27 shows a rear elevation view of the portable vanity lighting system of FIG. 15 in the first rotational position, and positioned in front of the user's face;

FIG. 28 shows a front perspective view of the portable vanity lighting system of FIG. 15 in a second rotational position, and positioned in front of the user's face;

FIG. 29 shows a side elevation view of the portable vanity lighting system of FIG. 15 in the second rotational position, and positioned in front of the user's face; and,

FIG. 30 shows a rear elevation view of the portable vanity lighting system of FIG. 15 in the second rotational position, and positioned in front of the user's face.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present specification,” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

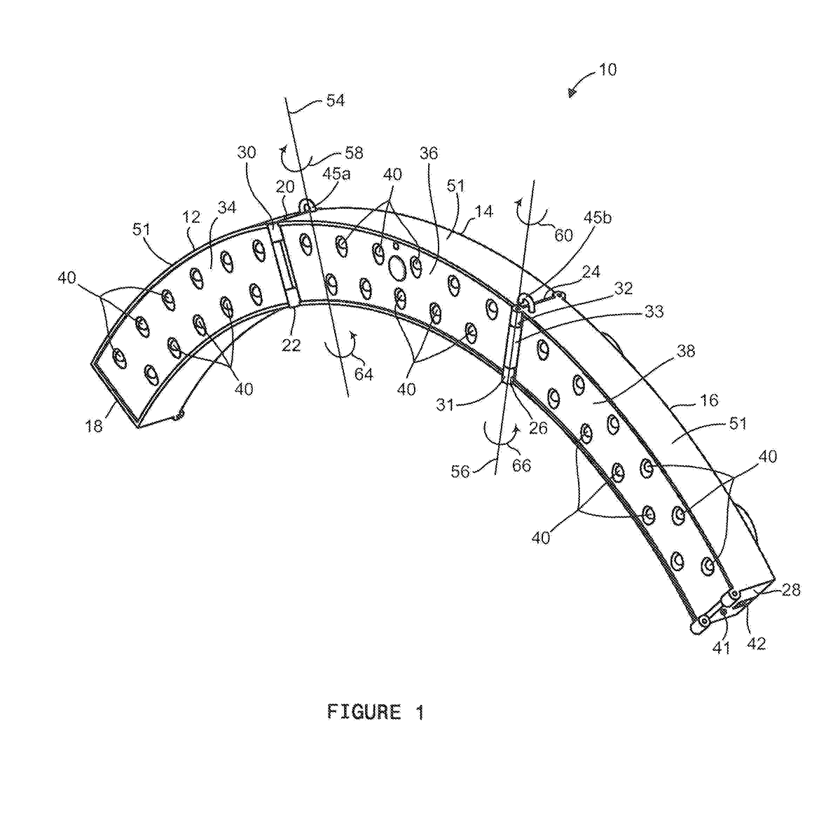

As exemplified in FIGS. 1 to 3, portable vanity lighting system 10 includes a plurality of illuminating members arranged on a plurality of segments. The plurality of segments can be selectively folded into a closed position for easy transportation and storage, or unfolded into an open position to provide vanity lighting.

As shown, vanity lighting system 10 includes a left segment 12, a center segment 14, and a right segment 16. Left segment 12 is shown including laterally opposed first and second ends 18 and 20, center segment 14 is shown including laterally opposed first and second ends 22 and 24, and right segment 16 is shown including laterally opposed first and second ends 26 and 28. Left segment 12 includes a front face 34, center segment 14 includes a front face 36, and right segment 16 includes a front face 38. Left segment 12 includes a rear face 46, center segment 14 includes a rear face 48, and right segment 16 includes a rear face 50.

It will be appreciated that vanity lighting system 10 may include any number of segments. For example, vanity lighting system 10 may include only two segments, or it may comprise greater than three segments (e.g. four or five segments).

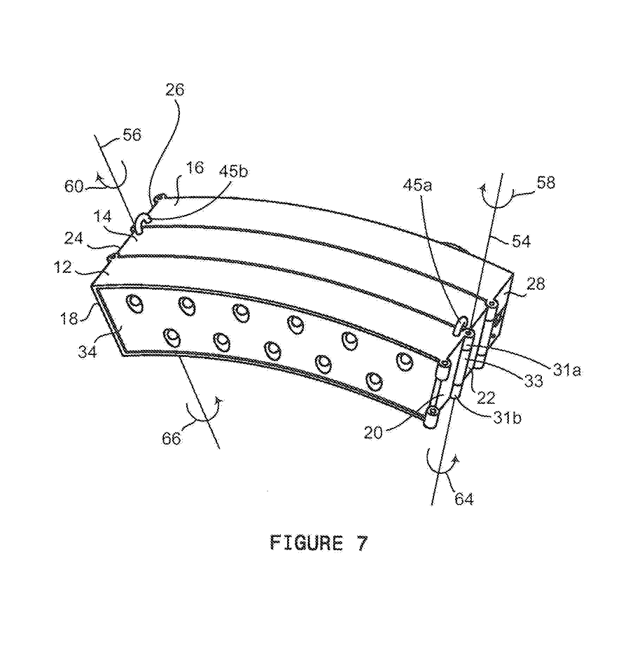

Segments 12, 14, and 16 are shown hingedly connected together in series. As shown, second end 20 of left segment 12 is hingedly connected by a hinge 30 to first end 22 of center segment 14. Similarly, second end 24 of center segment 14 is shown hingedly connected by a hinge 32 to first end 26 of right segment 16. The hinges may be positioned and/or configured so as to permit the segments to overlie each other, and preferably abut, when in the closed or folded position exemplified in FIG. 7.

Hinges 30 and 32 may be of any type known in the art. In some examples, one or both of hinges 30 and 32 includes mating portions 31, 33 of the segments it hingedly connects. It will be appreciated that mating portions 31, 33 may be discrete components that are fastened to a segment or integral with a segment. For example, one or both of hinges 30 and 32 may be a conventional surface mounted cabinet hinge, a butt hinge, a tee-hinge, a strap hinge, a gate hinge, a soss hinge, or a butterfly hinge. In some examples, one or both of hinges 30 and 32 joins the segments it hingedly connects by a flexible segment of material such as fabric, leather, or plastic (e.g. a living hinge). As exemplified in FIG. 7, a hinge may comprise a first mating portion 31 comprising upper and lower sections 31a, 31b secured to one segment and a second mating portion 33 that is receivable between the upper and lower portions and secured in position by a pivot pin (not shown).

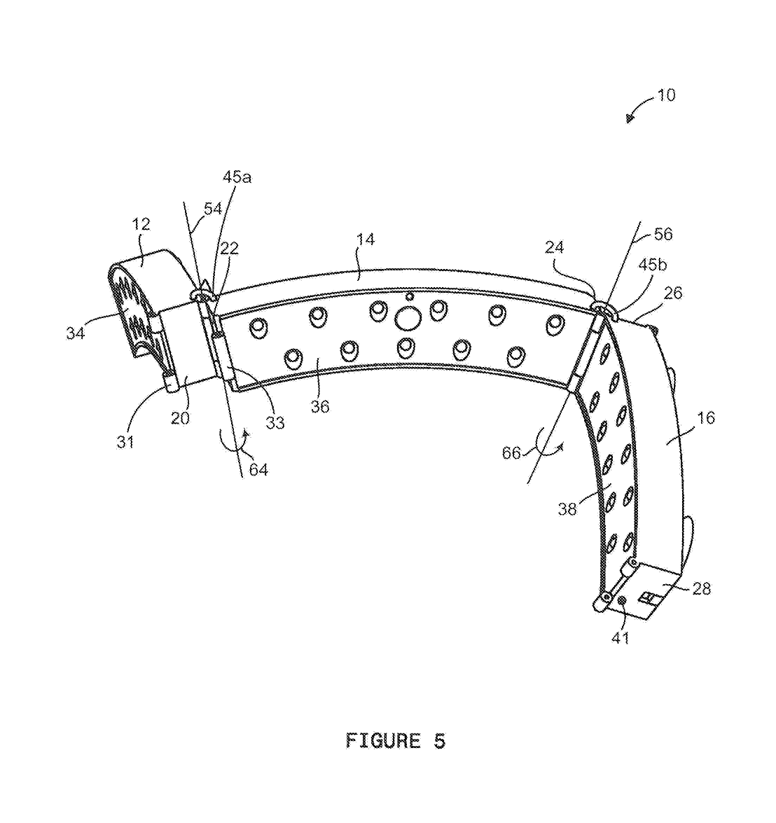

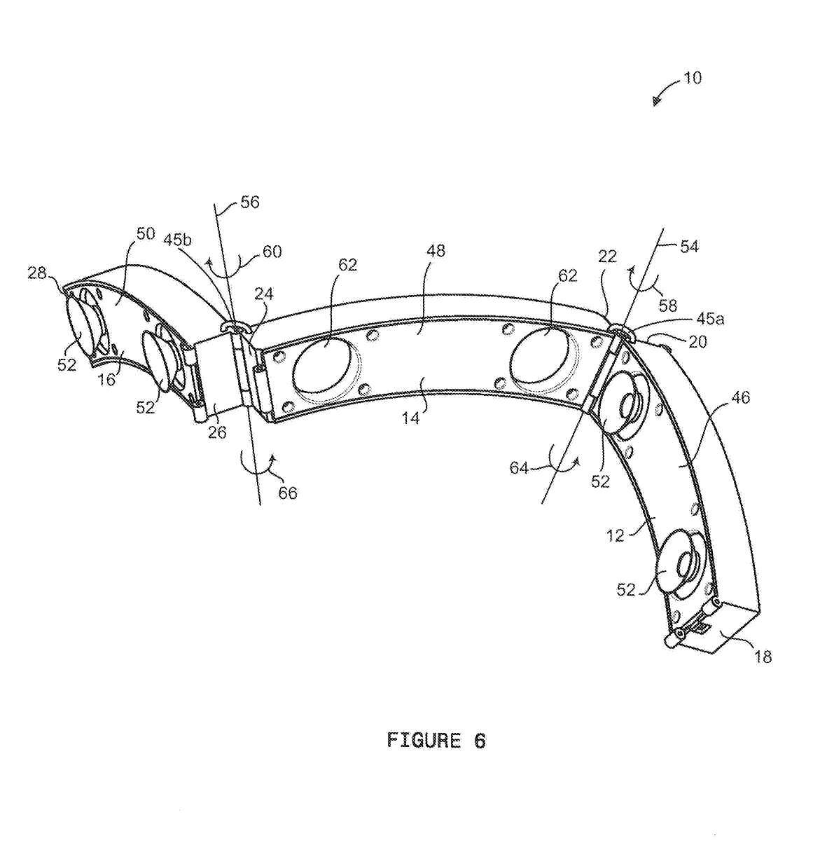

As exemplified, some of the segments may have a mating portion 31, 33 of a hinge provided on each opposed side and/or on each of front and rear faces. An advantage of this design is that the flexibility of the manufacturing process is enhanced as each segment may be useable as the left, center or right segment. For example, center segment 14 is provided with mating section 33 on first end 22 adjacent front face 36, a mating portion 31 on second end 24 adjacent front face 36, a mating section 31 on first end 22 adjacent rear face 48, and a mating portion 33 on second end 24 adjacent rear face 48. Each of segments 12 and 16 may have a similar constructions. Accordingly, as exemplified in FIGS. 5 and 6, segments 12 and 14 may be hingedly connected together at rear faces 46, 48 and segments 14 and 16 may be hingedly connected together at front faces 36, 38 so as to facilitate the segments overlying each other in the closed or folded position exemplified in FIG. 7. It will be appreciated that, while mating portions 31, 33 are shown provided on the front/rear faces, depending upon the hinge construction, the hinges may be provided at alternate locations, such as on the ends.

As shown, each of front faces 34, 36, and 38 includes a plurality of illuminating members 40 (some illuminating members 40 are not labeled in the figures to avoid cluttering the figures). Illuminating members 40 can be any suitable source of light. In some examples, one or more of illuminating members 40 is a light emitting diode (LED), incandescent bulb, or compact fluorescent bulb. In some cases, LED illuminating members 40 may provide a compactness that enhances the portability of portable vanity lighting system 10. In some cases, where portable vanity lighting system 10 is battery-powered, LED illuminating members 40 may enhance the longevity of portable vanity lighting system 10 on a single charge. Preferably, illuminating members 40 are recessed in the front face of the segments. Accordingly, when in the closed position, the illuminating members are positioned so as to not contact the face of a segment facing the illuminating member 40. Alternately or in addition, the face of a segment facing the illuminating member 40 may have a recess positioned and configured to receive the illuminating member 40 therein.

In some embodiments, each illuminating member 40 is of the same type (e.g. LED, incandescent or compact fluorescent) and configuration (e.g. power consumption, color, and light output). In alternative embodiments, more than one type or configuration of illuminating member may be provided. In one example, left and right segments 12 and 16 include illuminating members 40 which have higher light output (typically measured in lumens) than illuminating members 40 of center segment 14. This may provide a more even distribution of light impinging on the subject (e.g. a user's face) positioned in front of portable vanity lighting system 10.

Each of segments 12, 14, and 16 is shown including eleven illuminating members. In alternative embodiments, one or more of segments 12, 14, and 16 includes fewer than or greater than eleven illuminating members. In some examples, one or more of segments 12, 14, and 16 includes between one and ten illuminating members. In some examples, one or more of segments 12, 14, and 16 includes between 15 and 50 illuminating members. In the example shown, segments 12, 14, and 16 each include the same number of illuminating members 40 (eleven). However, in alternative embodiments, one or more of segments 12, 14, and 16 includes a different number of illuminating members 40 than the other segments.

In the example shown, portable vanity lighting system includes a button 41 (see FIG. 1). Button 41 may be an on/off switch so as to toggle portable vanity lighting system on and off. In some examples, pressing button 41 sends a signal to a controller (not shown) which controls the light output of one or more of illuminating members 40. For example, in response to a signal from button 41, the controller may gradually increase the light output of illuminating members 40 (e.g. from zero to a predetermined light level), or gradually decrease the light output of illuminating members 40 (e.g. to zero). Alternately button 41 may be a dimmer switch, or in addition, a dimmer switch may be included.

In some embodiments, portable vanity lighting system includes one or more actuators (e.g. button, switch or dial) for selectively adjusting the light output of one or more of illuminating members 40. This may permit a user to adjust the light output of portable vanity lighting system 10 in accordance with the lighting in the room and to their liking. This may also permit a user to lower the light output of one or more of illuminating members 40 to reduce power consumption (e.g. where portable vanity lighting system is battery powered).

In response to an extended depression of button 41 (e.g. 1 or 2 seconds), the controller may control the light output of illuminating members 40 to repeatedly fluctuate (e.g. alternately gradually rise and gradually fall). The controller may stop fluctuating the light output level when button 41 is again depressed, thereby setting the light output level of illuminating members 40. This may permit the light output level of illuminating members 40 to be adjusting using a single actuator (e.g. button 41), which may be less costly and more compact than providing a dedicated second actuator (e.g. a dimmer such as a slider-switch or dial) for controlling light output levels. Still, in some embodiments (not shown), portable vanity lighting system 10 may include a dedicated actuator (e.g. a slider-switch or dial) for controlling the light output levels of illuminating members 40.

In some embodiments (not shown), portable vanity lighting system includes a light meter, and the controller dynamically adjusts the light output of one or more of illuminating members 40 in response to readings received from the light meter. In some examples, the controller reduces the light output of one or more illuminating members 40 in response to readings from the light meter indicative of bright ambient lighting. In some examples, the controller increases the light output of one or more illuminating members 40 in response to readings from the light meter indicative of dim ambient lighting.

In some embodiments, portable vanity lighting system 10 may automatically turn off after a predetermined period of time (e.g. 15 minutes). In some examples, portable vanity lighting system 10 may include a timer (not shown) that is activated when portable vanity lighting system 10 is turned on. In these examples, the controller turns the portable vanity lighting system 10 off when the timer sends a signal responsive to the predetermined period of time having expired.

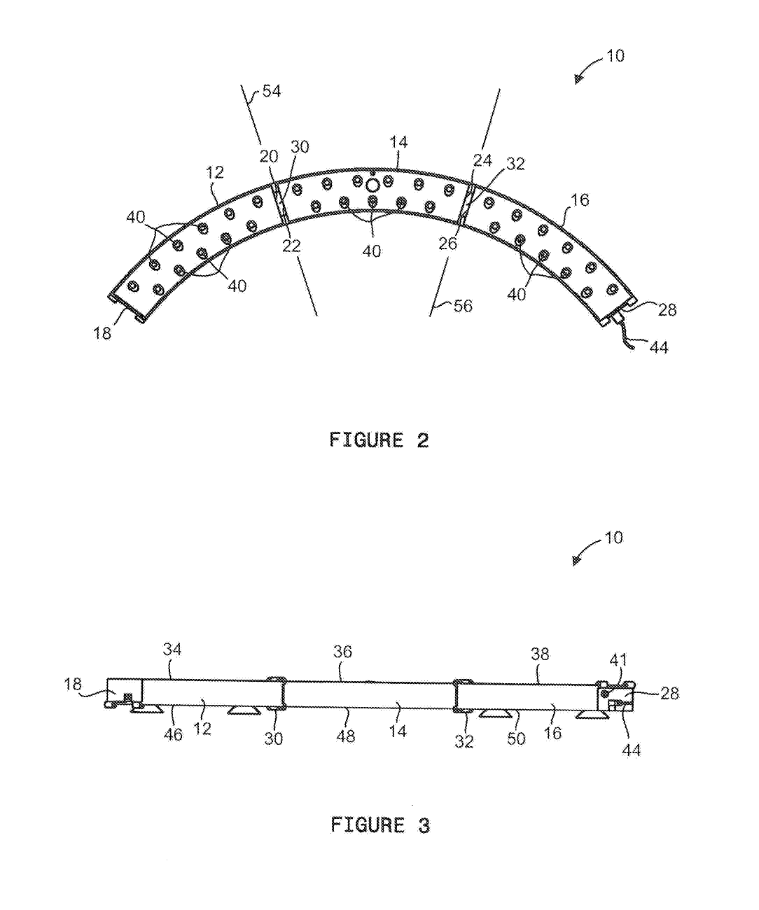

In the example shown, portable vanity lighting system 10 includes a power terminal 42 (see FIG. 1) for receiving a power cable 44 (see FIGS. 2 and 3). Power cable 44 may transmit power (e.g. DC or AC power) from an external power source (e.g. electrical wall outlet, power generator, or battery pack) to portable vanity lighting system 10 for powering illuminating members 40. In some examples, power cable 44 is separable from power terminal 42 or permanently connected to power terminal 42. In some embodiments (not shown), portable vanity lighting system 10 includes one or more batteries in addition to or instead of power terminal 42 and power cable 44. The batteries can be removable or permanently installed in portable vanity lighting system 10 (e.g., a section of one of the components may have a battery compartment with an openable battery cover). In some examples (not shown), portable vanity lighting system 10 includes a charging circuit which permits the batteries to be recharged from power drawn from a power source through power cable 44 and power terminal 42. This may provide portable vanity lighting system 10 with both the reliability of external power, and the convenience of portable battery power. For example, battery power may be used where there may not be convenient access to an external power source (e.g. at a public washroom, or an ad-hoc dressing area).

Each segment 12, 14, and 16 of portable vanity lighting system 10 may be individually supplied with power (e.g., each may have a battery compartment) or the segments 12, 14, and 16 may be electrically connected to each other by any means known in the art, such as by an electrical cable 45. In the example shown, segment 12 is electrically connected to segment 14 by a cable 45a, and segment 14 is electrically connected to segment 16 by a cable 45b. As shown, each cable 45a and 45b is positioned proximate to the hinge 30, 32 which connects the segments 12, 14, 14, 16. This may reduce the variation in distance that the cable extends between the connecting segments 12 and 14, or 14 and 16 when the segments 12, 14, and 16 are selectively folded.

In the example shown, each cable 45 extends between the upper faces 51 of segments 12 and 14, and segments 14 and 16. An advantage of this design is that the cable 45 is positioned exterior to the opposed faces of the segments which abut when the segments are in the open position. Accordingly the cable 45 does not interfere with the opening or closing of the segments. In alternative embodiments, one or more of cables 45 extend between faces other than upper faces 51, such as between the front faces 34, 36, or 38, or the rear faces 46, 48, or 50 of the segments 12 and 14, or 14 and 16. In some examples, one or more of cables 45 is provided with slack sufficient and/or resilient extensibility to compensate for the variation in distance between the connecting segments 12 and 14, or 14 and 16 when segments 12, 14, and 16 are selectively folded.

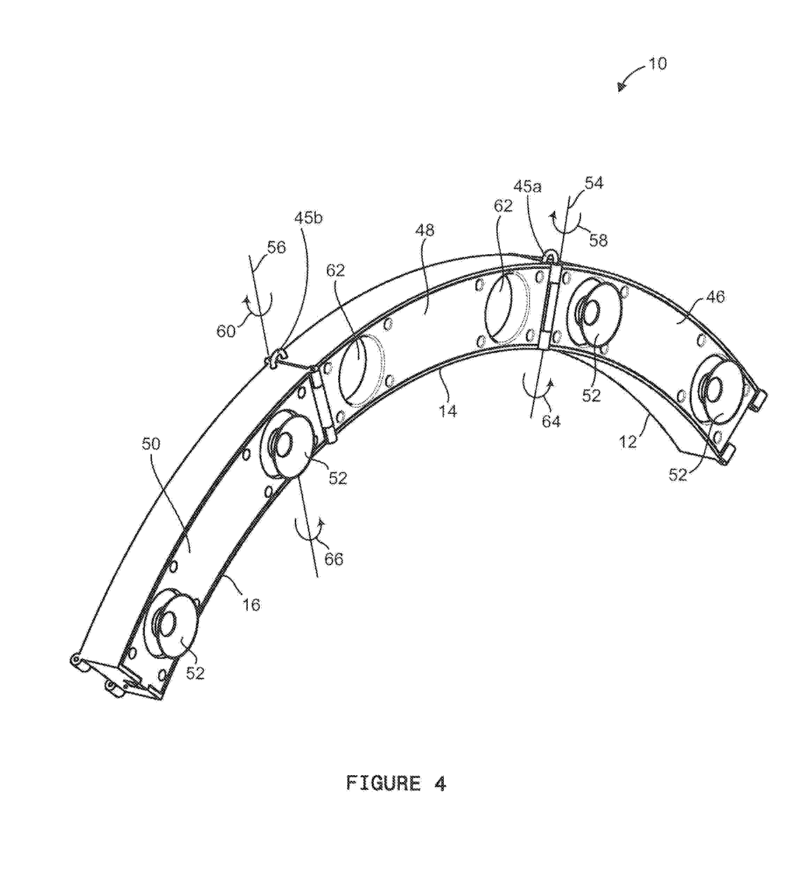

As exemplified in FIG. 4, rear faces 46 and 50 include securing devices 52 for mounting portable vanity lighting system 10 (e.g. to surface such as a wall or a mirror). Securing device 52 can be any suitable securing device for mounting portable vanity lighting system 10. In the example shown, securing devices 52 are suction cups. Suction cups may be especially suitable for mounting portable vanity lighting system 10 to a flat surface, such as a mirror. In some examples, one or more of securing devices 52 includes adhesive members (e.g. removable pressure-adhesive pads, or adhesive silicone pads). In some examples, one or more of securing devices 52 includes hooks, hook-and-loop fastening elements, magnets, or cables.

It will be appreciated that one or more of the segments may be provided with securing devices 52. In the example shown, each of left and right segments 12 and 16 includes two securing devices 52, and center segment 14 includes no securing devices 52. In alternative embodiments, left, right and center segments each include any number of securing devices 52. In one example, left and right segments 12 and 16 each include one securing device 52, and center segment 14 includes two securing devices 52. In another example, left and right segments 12 and 16 each include no securing devices 52, and center segment 14 includes three securing devices 52.

As exemplified in FIGS. 5-7, left and right segments 12 and 16 are each movable between an open position (see FIGS. 1 to 4), and a closed position (see FIG. 7). FIGS. 5 and 6 show left and right segments 12 and 16 partially folded in a position intermediate the open and closed positions. As shown in FIG. 3, front faces 34, 36, and 38 are preferably positioned side by side such that the front faces are in the same plane when the segments 12 and 16 are in the open position. In alternative embodiments, front faces 34, 36, and 38 are not in the same plane when in the open position. In some examples (not shown), one or more of front faces 34, 36, and 38 is at an angle to one or more of the other front faces 34, 36, and 38. In one example, left and right segments 12 and 16 are in the open position when partially folded as shown in FIGS. 5 and 6.

As shown, left segment 12 is rotatable with respect to center segment 14 about a pivot axis 54 positioned adjacent the rear faces 46, 48, and right segment 16 is rotatable with respect to center segment 14 about a pivot axis 56 adjacent the front faces 36, 38. Each of pivot axes 54 and 56 is shown extending in a plane that is parallel to front faces 34, 36, and 38. In the example shown, hinge 30 permits left segment 12 to rotate about pivot axis 54 in the direction of arrow 58 from the open position to the closed position, and hinge 32 permits right segment 16 to rotate about pivot axis 56 in the direction of arrow 60 from the open position to the closed position.

In the closed position, as shown in FIG. 7, segments 12, 14, and 16 overlie each other and preferably abut. As shown, left segment 12 overlies rear face 48 of center segment 14, and right segment 16 overlies front face 36 of center segment 14. In alternative embodiments, when in the closed position, left segment 12 overlies front face 36, and right segment 16 overlies rear face 48.

Preferably, as exemplified, when in the closed position, rear face 46 of left segment 12 is adjacent and parallel to rear face 48 of center segment 14, and front face 38 of right segment 16 is adjacent and parallel to front face 36 of center segment 14. As shown, rear face 48 of center segment 14 includes recesses 62. Recesses 62 are sized and positioned to receive securing devices 52 of a segment 12 or 14 which overlies rear face 48 in the closed position. In the example shown, rear face 48 includes two recesses 62, each sized and positioned to receive a different one of the two securing devices 52 on rear face 46 of left segment 12, when left segment 12 is in the closed position. This may permit rear faces 46 and 48 to come into close contact (and be optionally flush) when left segment 12 is in the closed position. In alternative embodiments (not shown), rear face 48 of center segment 14 includes one or more securing devices 52, and rear face 46 includes one or more recesses sized and positioned to collectively receive the one or more securing devices 52 on rear face 48 when left segment 12 is in the closed position.

In the example shown, each recess 62 is sized and positioned to receive one securing device 52. In alternative embodiments (not shown), one or more recesses 62 is sized and positioned to receive more than one securing device 52. In still other embodiments (not shown), none of segments 12, 14, and 16 includes any recesses 62. In some examples, securing devices 52 on a rear face, which overlies a face of another segment in the closed position, makes contact with and optionally secures to the face of that other segment. In some examples, one or more securing devices 52 on the rear face of a segment is moveable between an active position, in which the securing device 52 extends from the rear face of that segment for securing to, e.g. a wall; and an inactive position, in which the securing device 52 is removed from or recessed inside the rear face of that segment.

In at least some embodiments, one or more of illuminating members 40 are recessed from their respective front face 34, 36, or 38. This may protect illuminating members 40 from damage, and may further permit front face 36 to overlie front face 38 in the closed position without interference from illuminating members 40. In alternative embodiments (not shown), illuminating members 40 extend outwardly beyond their respective front face 34, 36, or 38. In some examples, a space remains between front faces 36 and 38 when in the closed position or the faces may have recesses to receive therein the illuminating members of the opposed face. This may provide space for illuminating members 40 to protrude from front faces 36 and 38.

In some embodiments, the rotation of hingedly connected segments is constrained between the open position and the closed position. In the example shown, interference between second end 20 and first end 22 prevents left segment 12 from rotating beyond the open position in the direction of arrow 64. Similarly, as shown interference between second end 24 and first end 26 prevents right segment 16 from rotating beyond the open position in the direction of arrow 66. Further, in the example shown, interference between rear face 46 and rear face 48 prevents left segment 12 from rotating beyond the closed position in the direction of arrow 58, and interference between front face 36 and front face 38 prevents right segment 16 from rotation beyond the closed position in the direction of arrow 60. In alternative embodiments, one or more of hinges 30 and 32 may constrain the segments it hingedly connected between the open position and the closed position without reliance on interference between the segments (e.g., the hinges may permit on a 180 degree of motion. In other alternative embodiments (not shown), the rotation of hingedly connected segments is not constrained between the open position and the closed position.

As shown in FIG. 7, when segments 12 and 16 are in the closed position, portable vanity lighting system 10 is compactly configured for convenient storage, or travel (e.g. in luggage, a suitcase or a backpack). In some embodiments, portable vanity lighting system 10 is still operable in the closed position. This may permit portable vanity lighting system 10 to be more easily secured, by securing devices 52, to a small external surface (e.g. a small mirror). In some embodiments, one or more of illuminating members 40 is rendered inoperably when one or more of segments 12 and 16 are in the closed position.

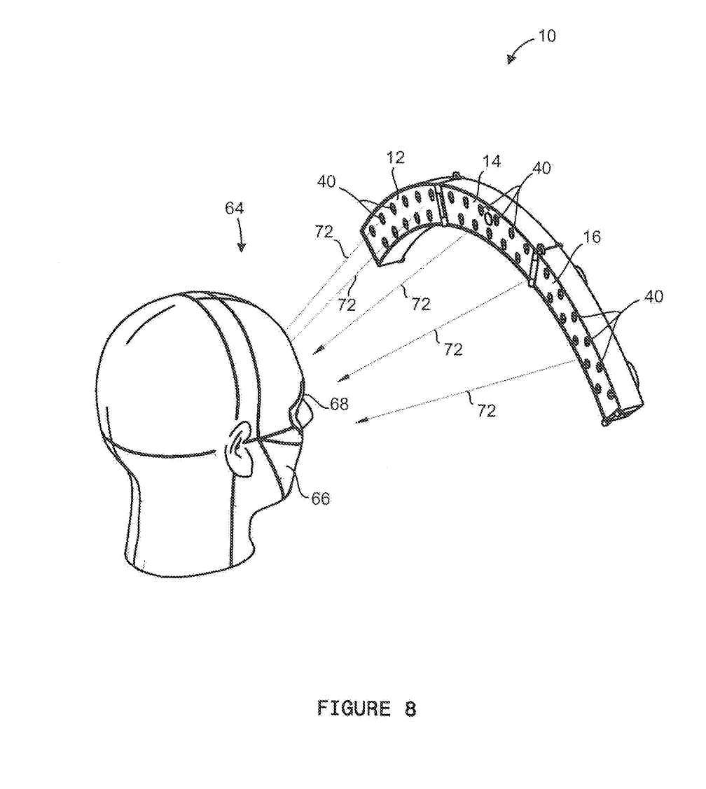

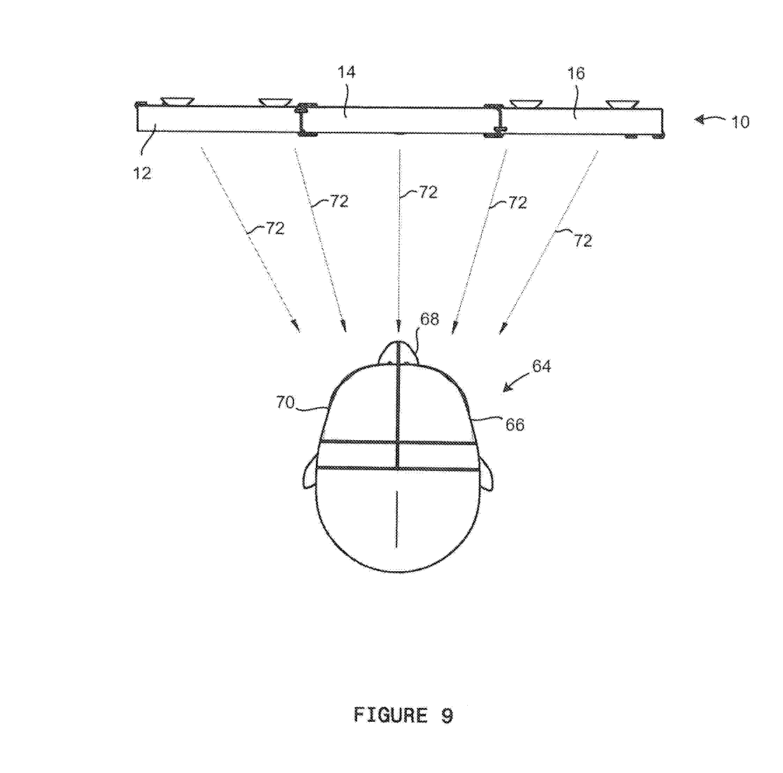

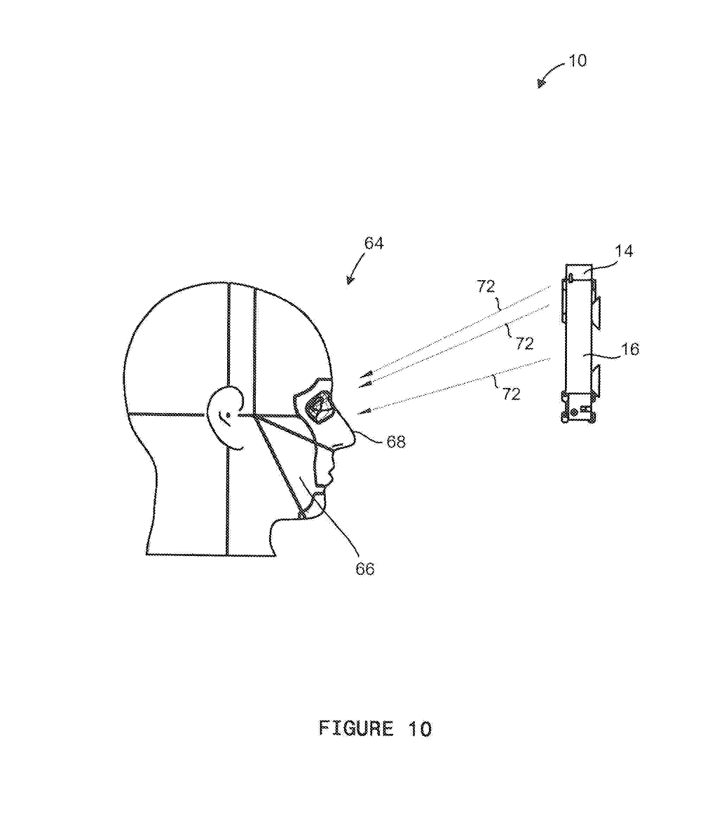

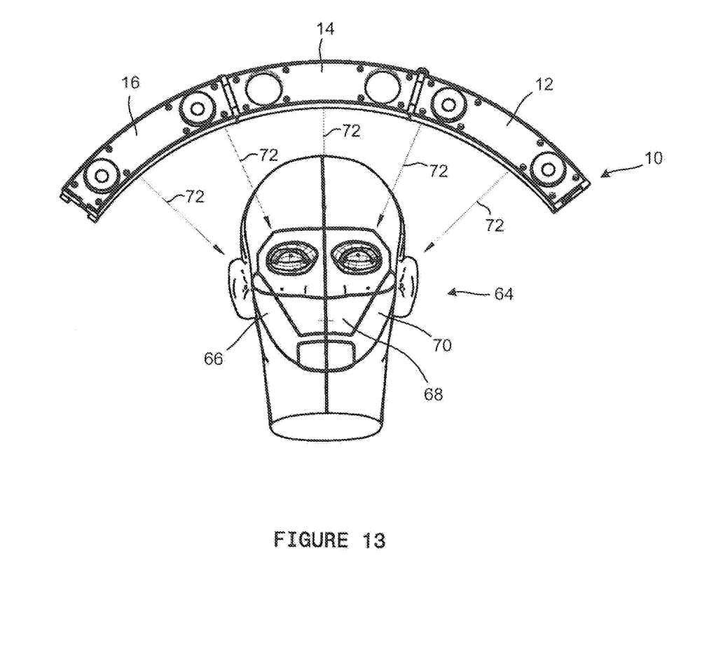

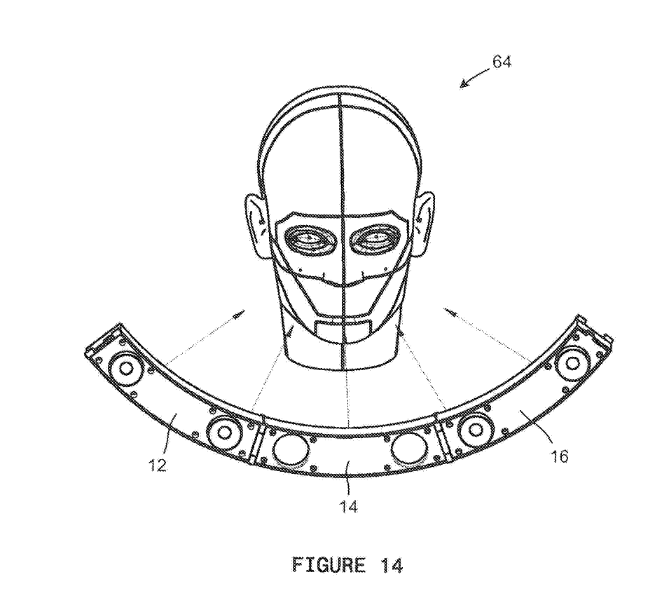

As exemplified in FIGS. 8 to 10 and 13, when in the open position, segments 12, 14, and 16 are arranged in an arc. In at least some embodiments, the arc shape may anatomically match the shape of a user's head. When portable vanity lighting system 10 is positioned in front of face 64, as shown, illuminating members 40 provide illumination in the direction of arrows 72 to a left side 66, center portion 68, and right side 70 of face 64. This may help to evenly illuminate face 64 and reduce the appearance of shadows. Further, the arc shape of segments 12, 14, and 16 may position illuminating members 40 at multiple different elevations. This may further enhance even illumination of face 64 and further reduce the appearance of shadows.

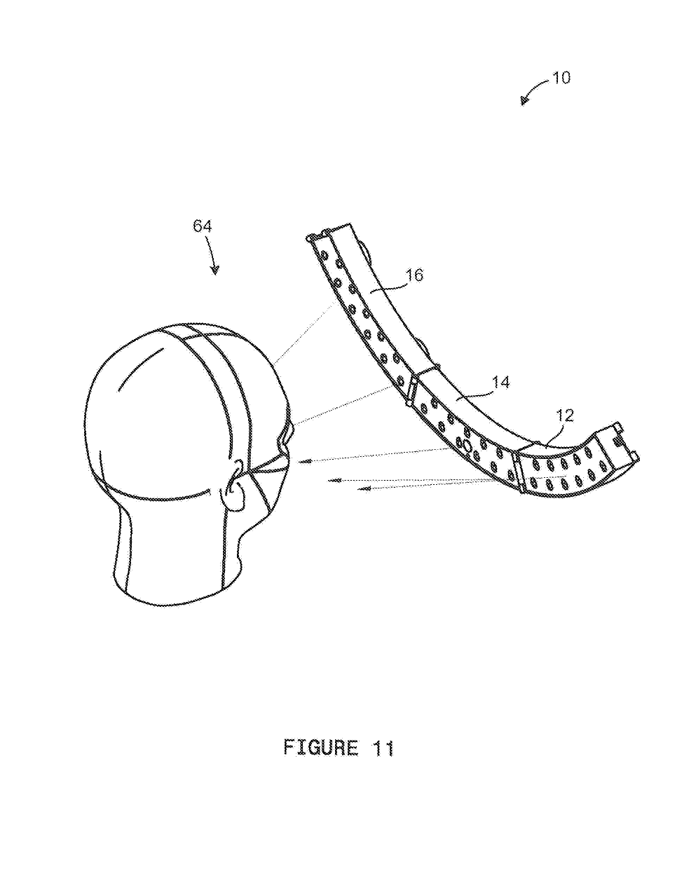

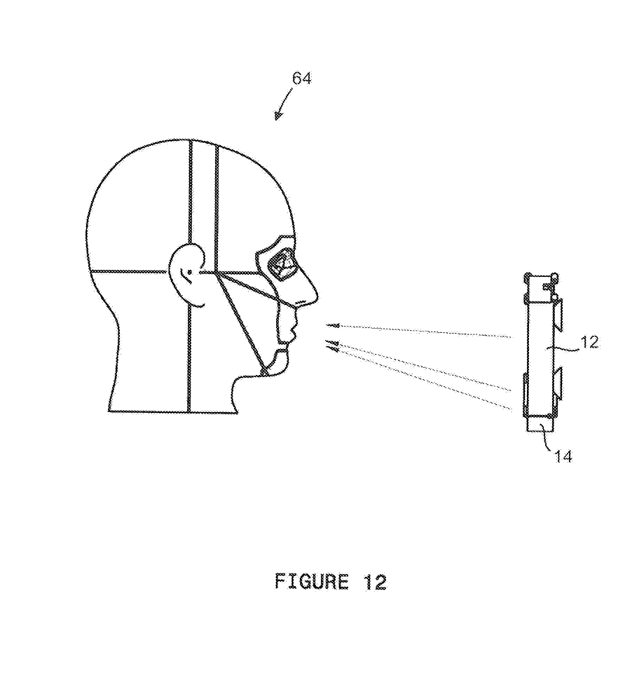

In at least some embodiments, portable vanity lighting system 10 can be secured to a surface in any of a plurality of different rotational positions. FIGS. 8 to 10 and 13 show an example of portable vanity lighting system 10 rotationally positioned with segments 12, 14, and 16 arcing upwardly. In at least some cases, this may provide better illumination for an upper portion of face 64. FIGS. 11, 12 and 14 show an example of portable vanity lighting system 10 rotationally positioned with segments 12, 14, and 16 arcing downwardly. In at least some cases, this may provide better illumination for a lower portion of face 64. In some cases, portable vanity lighting system 10 is positioned in any of a plurality of other rotational positions. In some examples, portable vanity lighting system 10 is rotationally positioned with segments 12, 14, and 16 arcing to the left or to the right.

In some embodiments, a portable vanity lighting system may include a plurality of groups of segments (“segment groups”). Each segment group may include one segment, or two or more hingedly connected segments (e.g. two to ten segments). The segment groups may be connected to each other, such as by a flexible elongate member such as a cord or wire, so that the groups of segments may be positioned at different positions so as to illuminate different portions of a user's face.

The segment groups may connected to each other by an electrically conductive member so that the group of segments are electrically connected to each other (e.g. in series or in parallel). This may permit the segment groups to share a common power source, e.g. for powering each of the segments in the segment groups and/or for recharging the local power source(s) (e.g. rechargeable batteries) of each of the segment groups and/or for controlling the illumination provided by the group of segments, e.g., an on/off switch and/or a dimmer.

Preferably, the segment groups may be spaced apart and electrically connected. For example, each segment group may be electrically connected to at least one other segment group in any suitable manner, such as by a flexible electrical cable. This may permit each segment group to be selectively positioned in spaced apart relation to each other segment group while having the advantage of being electrically connected together. Accordingly, a user may selectively direct light from the portable vanity lighting system, e.g., with emphasis on a facial region of interest. Further, this may permit each segment group to be selectively mounted where appropriate on different mounting surfaces.

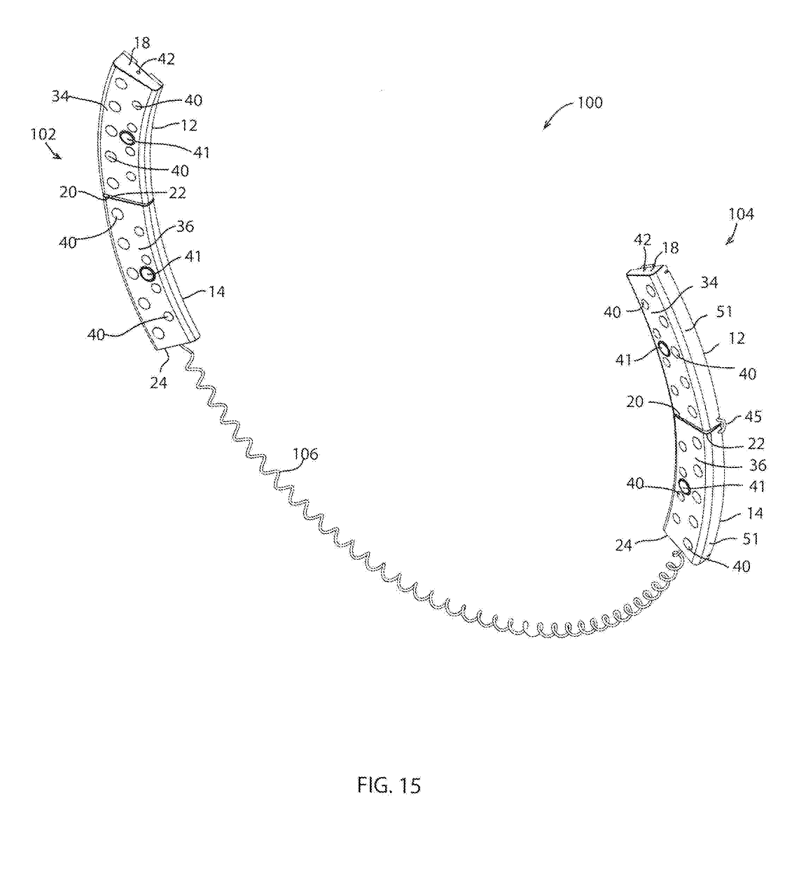

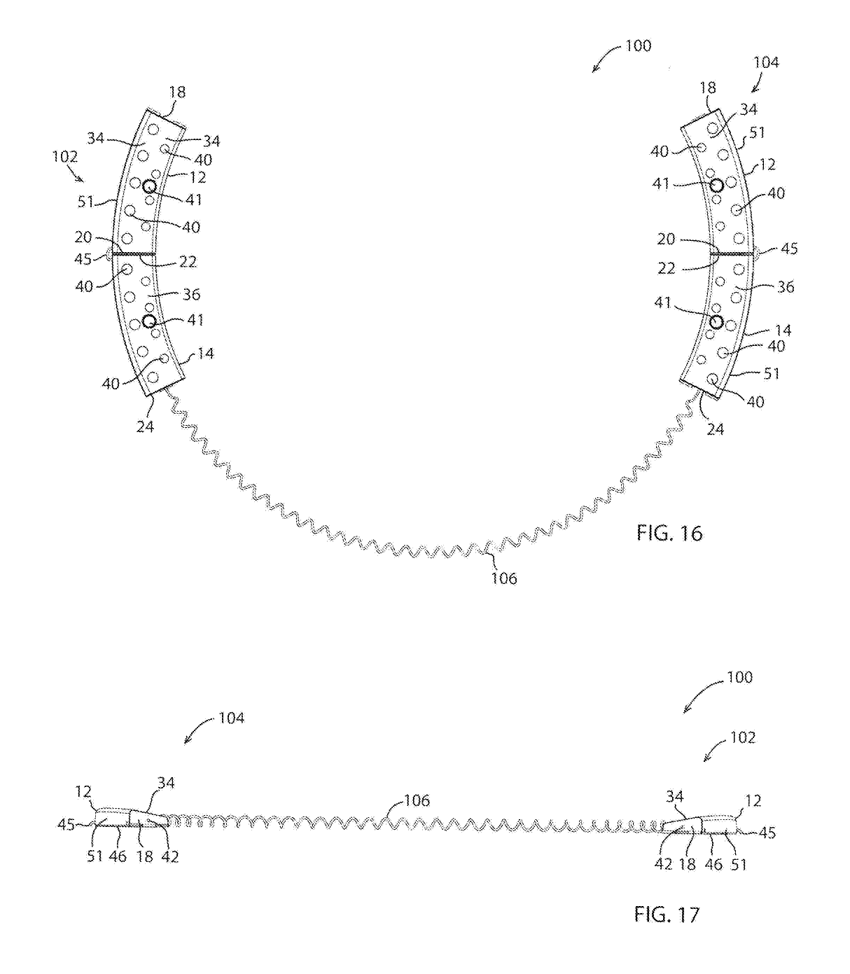

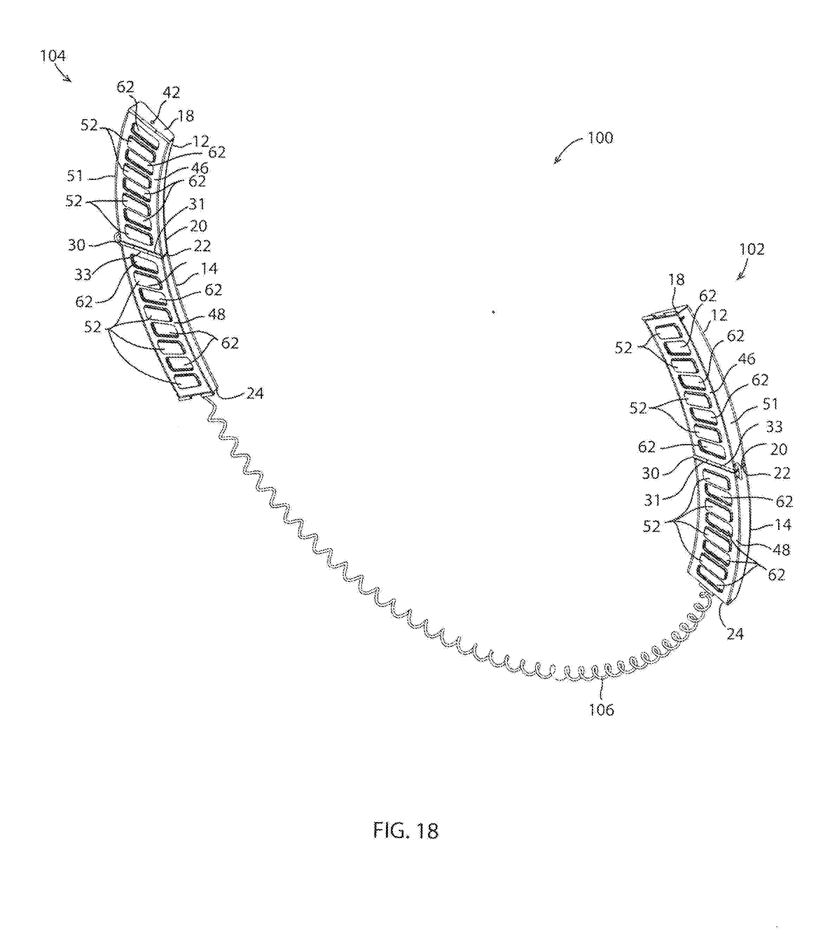

Reference is now made to FIGS. 15 to 18, where like part numbers refer to like parts in the previous figures, and where a portable vanity lighting system 100 is shown in accordance with another embodiment. Portable vanity lighting system 100 is similar to portable vanity lighting system 10 in may respect except, for example the number and arrangement of segments.

In the illustrated example, portable vanity lighting system 100 includes first and second segment groups 102 and 104. Each segment group 102 and 104 may include any number of hingedly connected segments, and each segment group 102 and 104 may include the same or a different number of segments. As exemplified, each of segment groups 102 and 104 includes a first segment 12 connected to a second segment 14. In alternative embodiments, one or more of segment groups 102 and 104 may include only one segment, or may include three or more segments.

The segment groups of portable vanity lighting system 100 may be electrically connected in any suitable fashion. Preferably, the segment groups are electrically connected by a length of flexible electrical cable. This may permit the segment groups to be freely positioned with respect to one another. In the illustrated example, first segment group 102 is electrically connected to second segment group 104 by a coiled electrical cable 106. Coiled electrical cable 106 may be resiliently extendible. This may permit coiled electrical cable 106 to extend when segment groups 102 and 104 are moved apart during use, and to contract when segment groups 102 and 104 are moved together for compact storage and transportation.

Electrical cable 106 (or a different suitable electrical conductor) may be connected to segment groups 102 and 104 in any suitable manner. In the illustrated example, electrical cable 106 is connected to outside ends 24 of the second segments 14 of first and second segment groups 102 and 104. Electrical cable 106 may be permanently connected to one or both of segment groups 102 and 104 as shown, or releasably connected to one or both of segment groups 102 and 104 such as by a plug and socket connection.

Portable vanity lighting system 100 may include one or more actuators for selectively controlling the illumination of illuminating members 40. For example, portable vanity lighting system 100 may include one or more ON/OFF switches, dimmer slides, or other digital or analogue controls, for controlling one or more of the power status (i.e. on or off), intensity, and color of one or more of the illuminating members 40. In the illustrated example, each segment 12 and 14 includes a respective button 41 for toggling the power status of the illuminating members 40 of that segment. This may permit each segment 12 and 14 to be selectively activated for controlling the illumination provided by portable vanity lighting system 100.

In some embodiments, one actuator may be operable to control the illumination of all illuminating members 40 of all segments in a group of segments or in all segments of the portable vanity lighting system. Accordingly, each group of segments may have a single actuator or the portable vanity lighting system may have a single actuator. In this latter embodiment, centralized control over all electrically connected segments is provided.

Alternately, one or more segments may have a button 41 and the buttons may be electrically connected such that any one button 41 may control all illuminating members 40. For example, each button 41 may be operable to control the illumination of all illuminating members 40 of all segments of a group of segments or all segments in the portable vanity lighting system. Accordingly, this embodiment provides a user with a multiplicity of buttons 41 with which the user may interact to control the illumination of all illuminating members 40 of all segments in the portable lighting system 100. For example, depending on the arrangement of each segment group 102 and 104 when mounted to a mounting surface (e.g. a mirror), there may be some buttons 41 that are more accessible than others to the user.

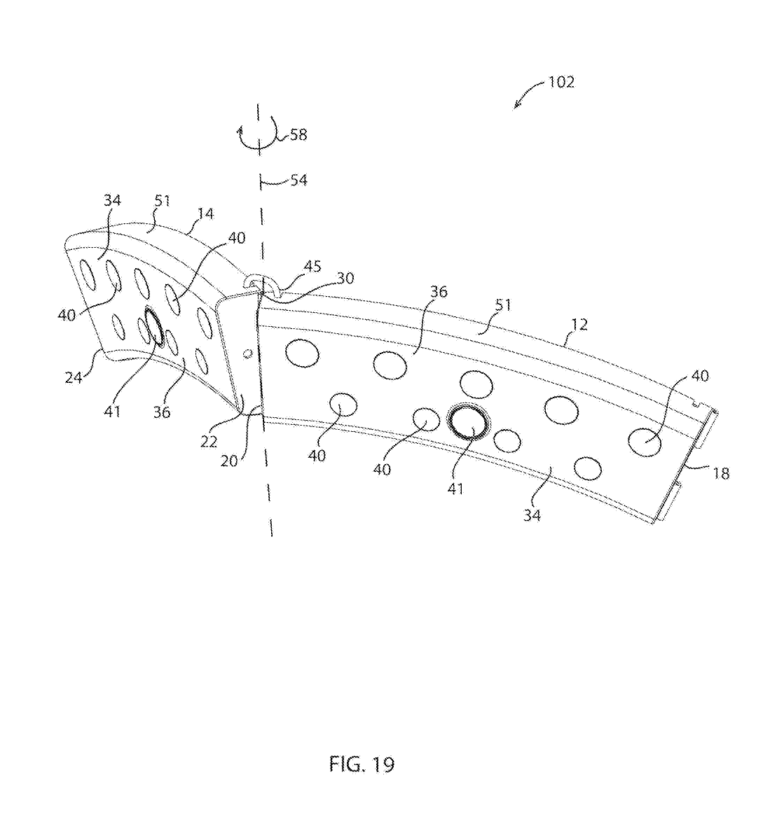

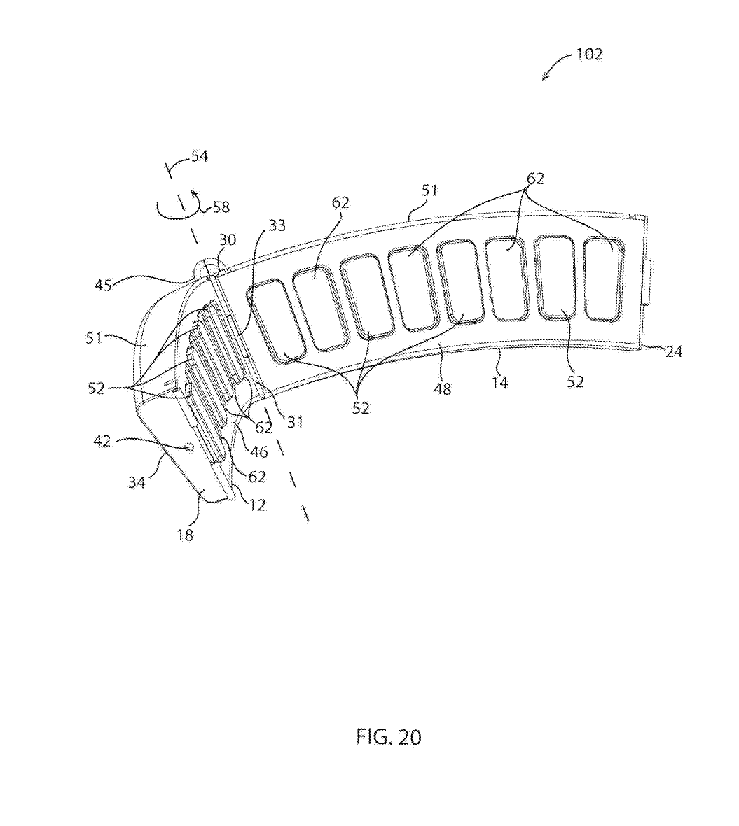

Each segment group 102 and 104 is preferably configured to mount to a mounting surface (e.g. a mirror) for directing light from illuminating members 40 in a desired direction (e.g. toward a user's face). Reference is now made to FIGS. 19-21 which show an exemplary segment group 102 containing segments 12 and 14. Segment group 104 may be configured similarly to segment group 102. In the illustrated example, each of segments 12 and 14 includes a plurality of securing devices 52 and a plurality of recesses 62 on the rear faces 46 and 48 thereof. Securing devices 52 may be adhesive members such as removable pressure-sensitive adhesive, suction cups or the like.

As shown, securing devices 52 alternate in position with recesses 62 between first and second ends 18 and 20, or 22 and 24 of rear faces 46 and 48 of first and second segments 12 and 14. However, other patterns may be used. It will be appreciated that each segment may have only one securing device 52 and one recess 62. Alternately one segment of a group of segments may have a securing device 52 and another segment of a group of segments may have a recess 62. It will be appreciated that various combinations may be used provided that the group of segments may be retained on a desired surface in a desired orientation.

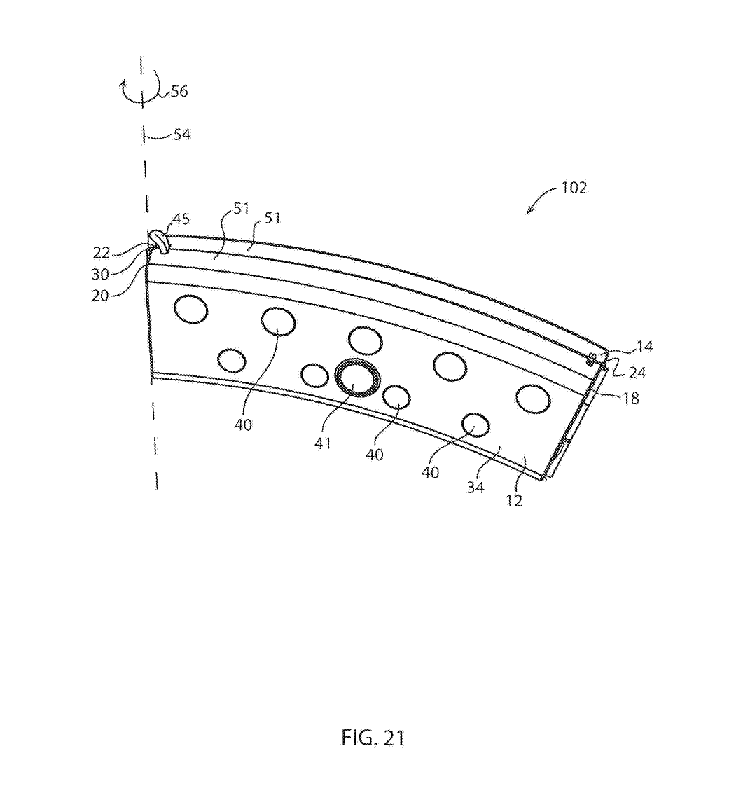

FIG. 21 shows an example of segment group 102 in a folded position where rear face 46 of first segment 12 overlies rear face 48 of second segment 14. Preferably, each securing device 52 of first segment 12 aligns with and is received in a corresponding recess 62 of second segment 14 when first and second segments 12 and 14 are folded about axis 54 in direction 58 into the folded position. Similarly, each securing device 52 of second segment 14 preferably aligns with and is received in a corresponding recess 62 of first segment 12 when first and second segments 12 and 14 are folded about axis 54 in direction 58 into the folded position. This may permit securing devices 52 to be compactly stored and protected from dirt and damage during storage and transportation. This may be advantageous for certain securing devices 52, such as suction cups and pressure sensitive-adhesive, which may lose effectiveness when exposed to dirt and which may inadvertently adhere to objects or surfaces if not covered.

Portable vanity lighting system 100 may be powered by an external power source (e.g. AC municipal power) and/or an internal power source (e.g. batteries). For example, one or more of segment groups 102 and 104 may be connectable to an external power source and/or have an internal power source. In some embodiments, power from one segment or segment group may be transmittable to another segment or segment group for powering that other segment or segment group.

In the illustrated example, in each segment group 102 and 104, segments 112 and 114 are connected by an electrical cable 45. This may permit power from one of segments 112 and 114 to be transmitted to the other segment 112 or 114, for powering the other segment 112 or 114.

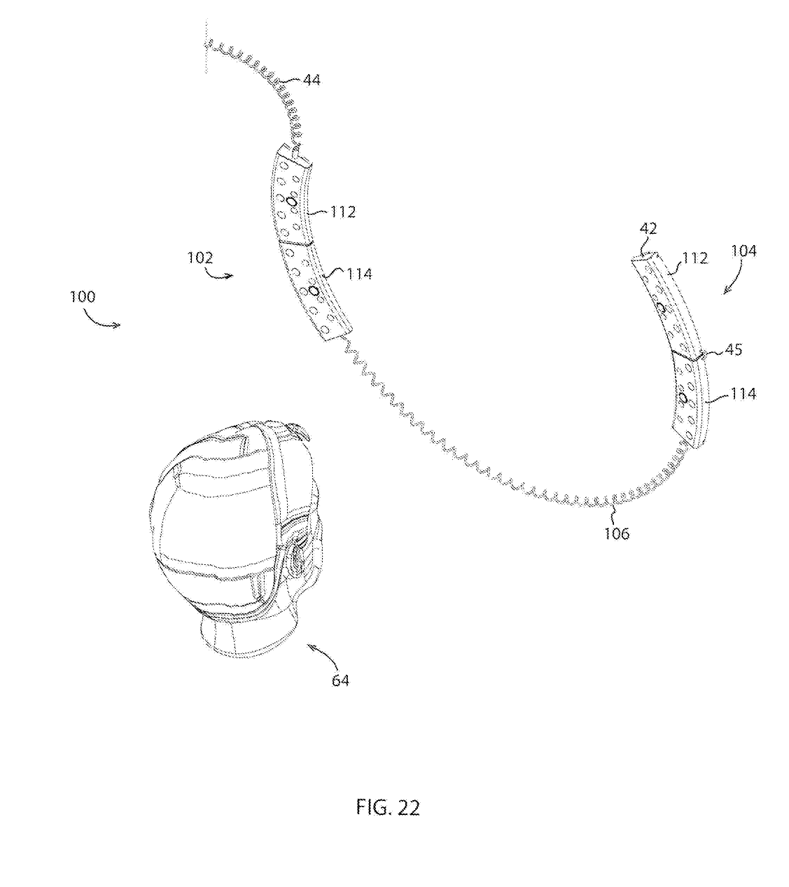

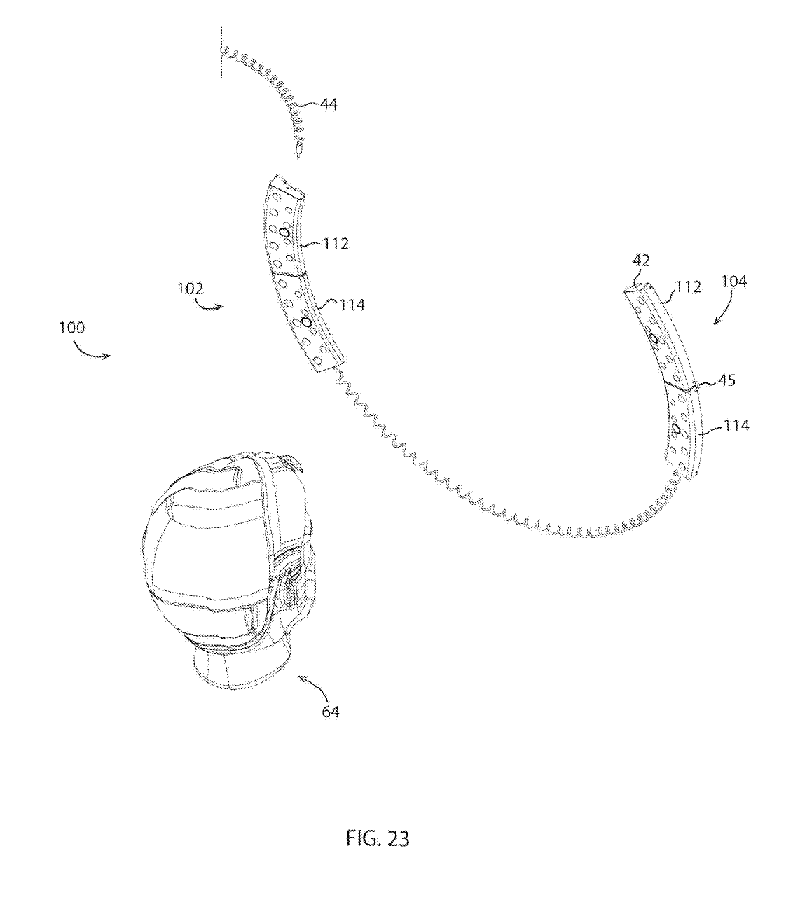

Reference is now made to FIGS. 22 and 23. As shown, segments 112 of segment groups 102 and 104 include a power terminal 42 for receiving a plug of a power cable 44. In turn power cable 44 which may include a transformer or the like so that DC power may optionally be supplied, may be connectable to, e.g. a wall outlet for receiving AC power, e.g., by using a suitable plug. In the illustrated example, when any one of segments 112 is connected to external power, such as by power cable 44, electrical power may be transmitted through cables 45 and 106 to the other segments 112 and 114 in the system 100. This may permit all segments 112 and 114 to be powered from a single electrical power source. Further, if one or more of the segments include a battery compartment, this may permit segments 112 and 114 containing rechargeable batteries positioned in the battery compartment or compartments to recharge from a single electrical power source.

Portable vanity lighting system 100 may include any number of segment groups. For example, any number of segment groups may be connected in series or in parallel for modularly expanding the size of system 100. In the illustrated example, terminals 42 may be connected to an electrical conductor, such as a coiled cable 106, for connecting additional segment groups in series.

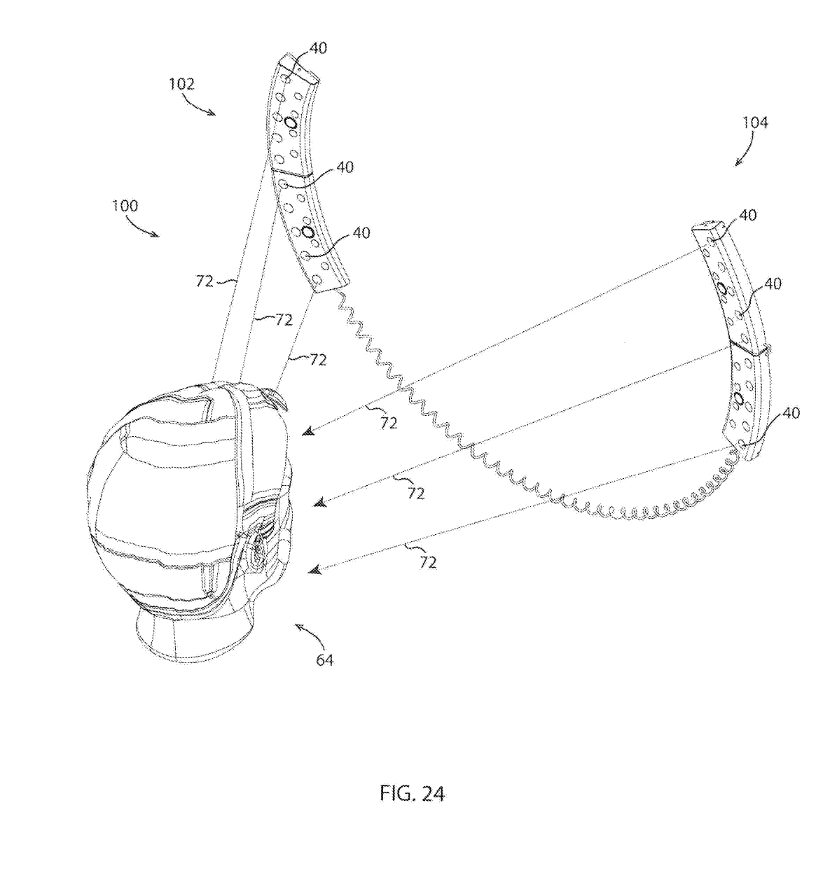

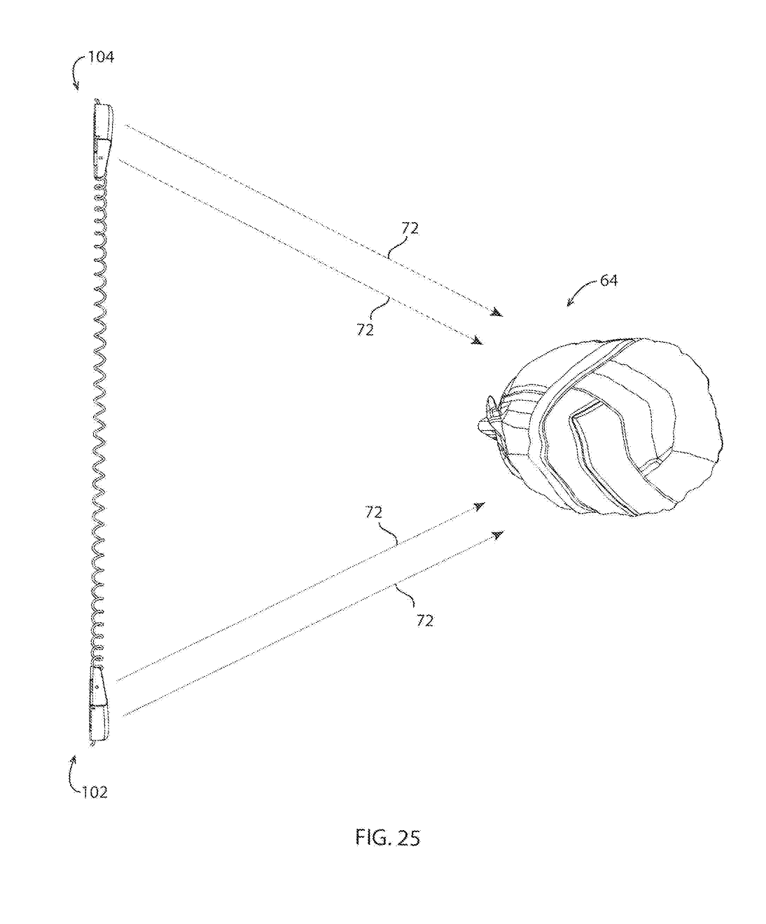

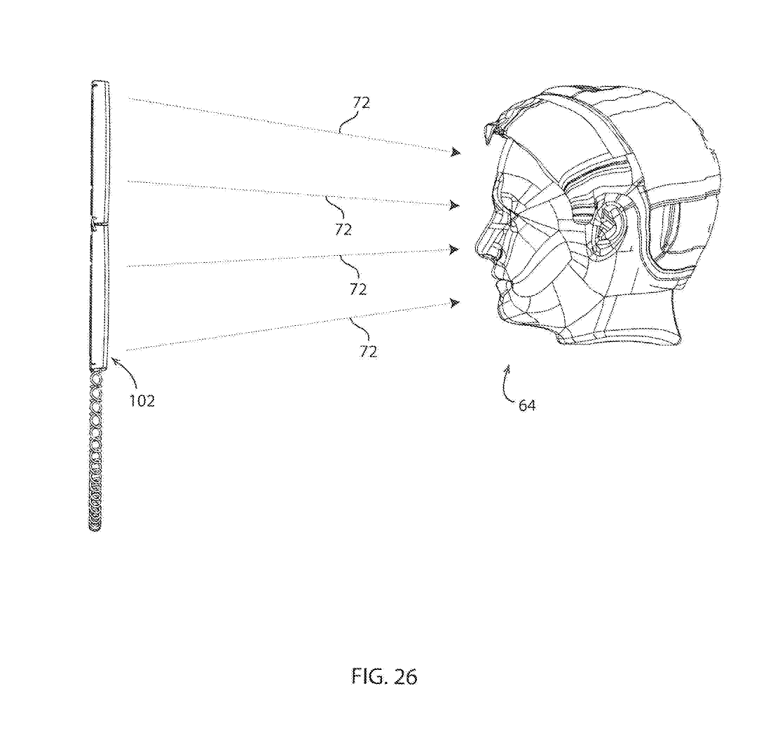

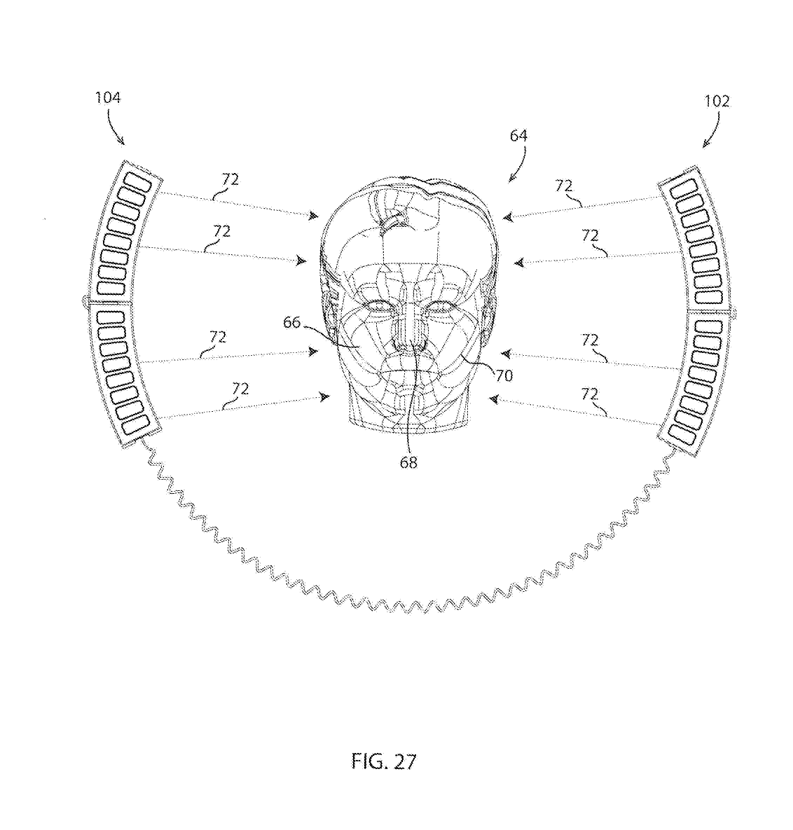

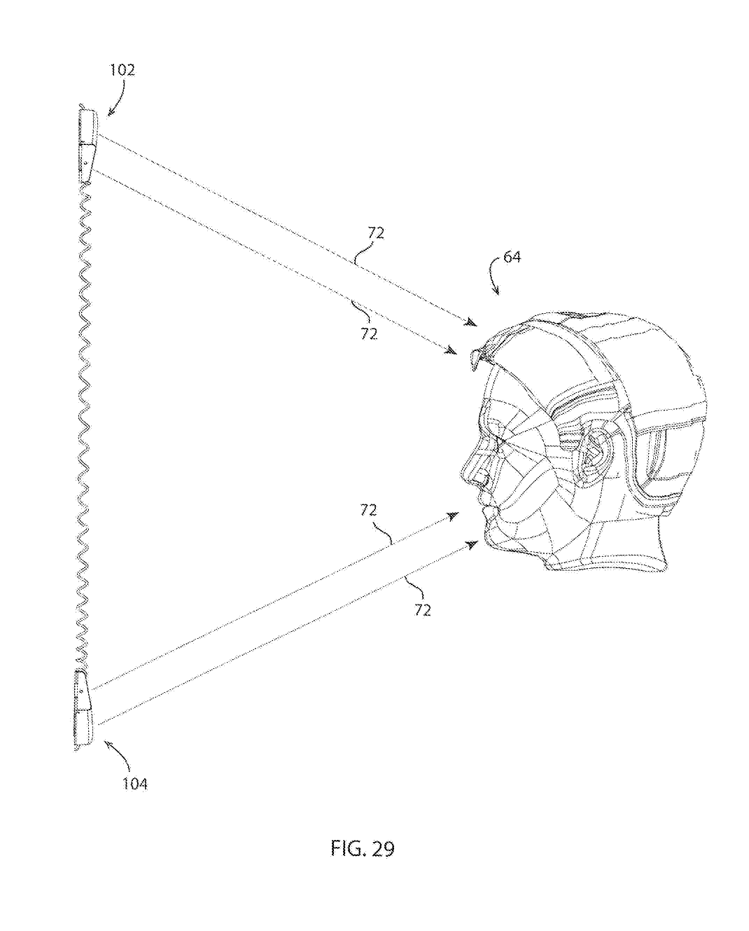

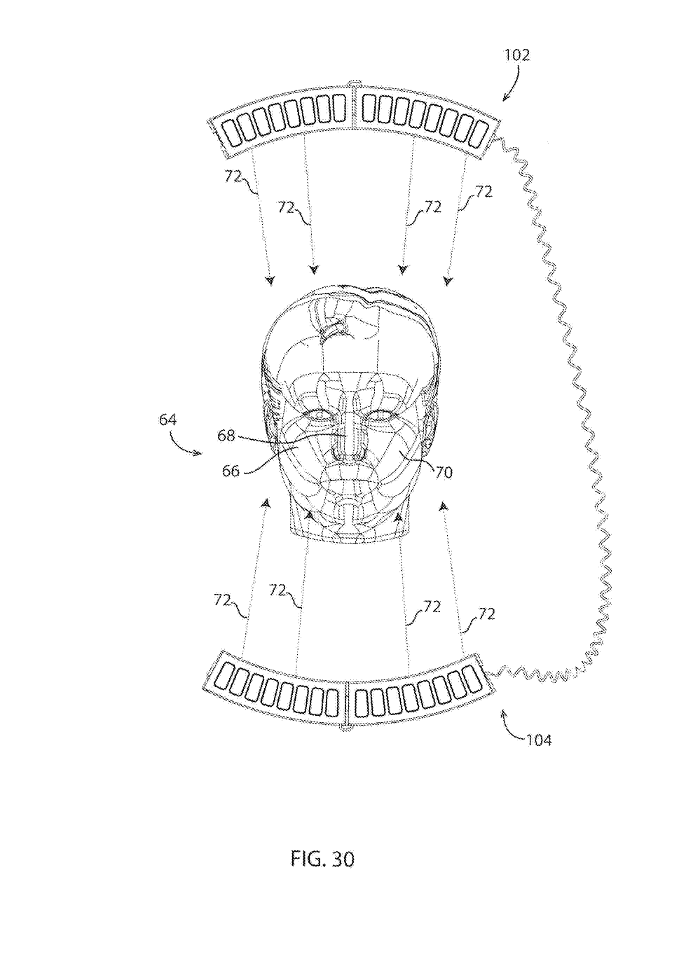

As exemplified in FIGS. 24-30, when in the open position, segment groups 102 and 104 may be arranged as opposing arcs. For example, segment groups 102 and 104 may form arcs of a common circle. In at least some embodiments, the arc shape may anatomically match the shape of a user's head. When portable vanity lighting system 100 is positioned in front of face 64, as shown, illuminating members 40 provide illumination in the direction of arrows 72 to a left side 66, center portion 68, and right side 70 of face 64. This may help to evenly illuminate face 64 and reduce the appearance of shadows. Further, the arc shape of segment groups 102 and 104 may position illuminating members 40 at multiple different elevations. This may further enhance even illumination of face 64 and further reduce the appearance of shadows.

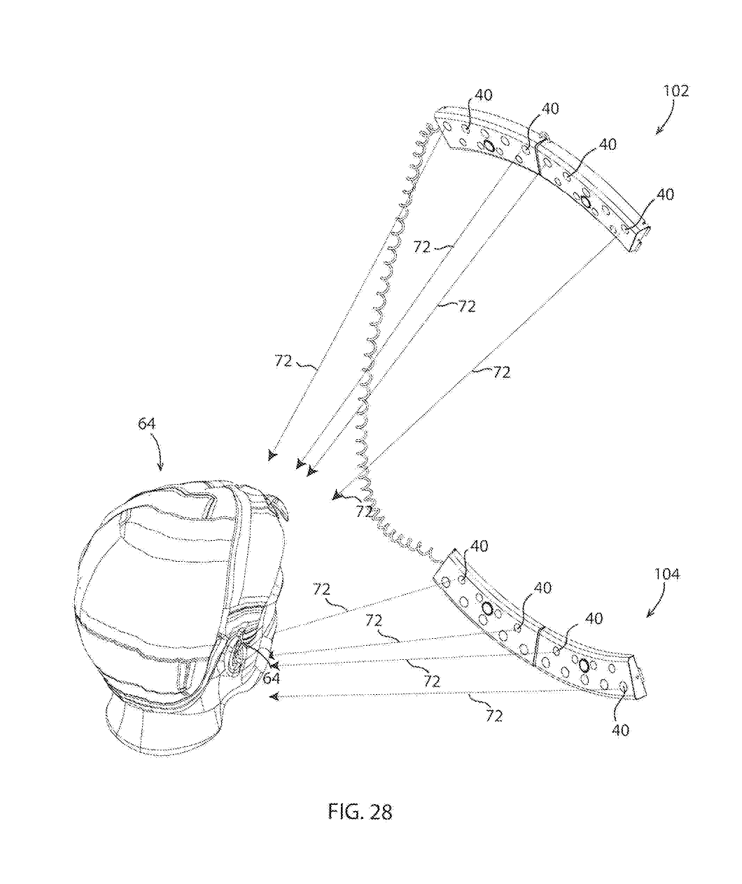

In at least some embodiments, portable vanity lighting system 100 can be secured to a surface in any of a plurality of different rotational positions. FIGS. 24-27 show an example of portable vanity lighting system 100 rotationally positioned with segment groups 102 and 104 arcing horizontally left and right, respectively. In at least some cases, this may provide better illumination for the left and right sides 66 and 70 of face 64. FIGS. 28-30 show an example of portable vanity lighting system 100 rotationally positioned with segment groups 102 and 104 arcing upwardly and downwardly, respectively. In at least some cases, this may provide better illumination for upper and lower portions of face 64. In some cases, portable vanity lighting system 100 is positioned in any of a plurality of other rotational positions. In some examples, portable vanity lighting system 100 is rotationally positioned with segment groups 102 and 104 arcing in the same direction.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1-41. (canceled)

42. A portable vanity lighting system comprising a plurality of segments comprising at least a center segment, a left segment and a right segment, each segment having a front face that is provided with at least one illuminating member, a rear face and first and second laterally spaced apart opposed ends, the left segment is hingedly connected to the first end of the center segment and moveable to a closed position in which the left segment overlies one of the front and rear faces of the center segment and the right segment is hingedly connected to the second end of the center segment and moveable to a closed position in which the right segment overlies the other of the one of the front and rear faces of the center segment, wherein a securing device is provided on the rear face of the segment which overlies the rear face of the center segment when in the closed position and the center segment has a recess for receiving the securing device.

43. The portable vanity lighting system of claim 42 wherein the left, center and right segments are arranged in an arc when in an open position.

44. The portable vanity lighting system of claim 42 wherein, when in an open position, the illuminating members provide illumination to illuminate a left side, a right side and a center portion of a face positioned in front of the portable vanity lighting system.

45. The portable vanity lighting system of claim 42 wherein the illuminating members are recessed in the segments.

46. The portable vanity lighting system of claim 45 wherein each segment comprises a plurality of illuminating members.

47. The portable vanity lighting system of claim 46 wherein the illuminating members comprise LEDs.

48. The portable vanity lighting system of claim 42 wherein the securing device comprises a suction cup.

49. The portable vanity lighting system of claim 42 wherein the securing device comprises adhesive members.

50. The portable vanity lighting system of claim 42 further comprising rechargeable batteries.

51. The portable vanity lighting system of claim 42 further comprising a controller configured to dim the light output of the at least one illuminating member of at least one of the plurality of segments in response to a signal from an actuator.

52. A portable vanity lighting system comprising a plurality of segments, each segment having a front face that is provided with at least one illuminating member, a rear face and first and second spaced apart opposed ends, the segments are hingedly connected together about pivot axis that extends in a plane that is parallel to the front face of the segments, the segments are moveable to an open position wherein the segments are positioned side by side with the front faces in the same plane and a closed position in which the segments overlie each other wherein a securing device is provided on the rear face of a first segment which overlies the rear face of a second segment when in the closed position and the second segment has a recess for receiving the securing device.

53. The portable vanity lighting system of claim 52 wherein the plurality of segments comprises at least a center segment, a left segment and a right segment, wherein, in the closed position, one of the right and left segments overlies the front face of the center section and the other of the right and left segments overlies the rear face of the center section.

54. The portable vanity lighting system of claim 52 wherein the segments are arranged in an arc when in an open position.

55. The portable vanity lighting system of claim 52 wherein, when in an open position, the illuminating members provide illumination to illuminate a left side, a right side and a center portion of a face positioned in front of the portable vanity lighting system.

56. The portable vanity lighting system of claim 52 wherein the illuminating members are recessed in the segments.

57. The portable vanity lighting system of claim 56 wherein each segment comprises a plurality of illuminating members.

58. The portable vanity lighting system of claim 56 wherein the illuminating members comprise LEDs.

59. The portable vanity lighting system of claim 52 wherein the securing device comprises a suction cup.

60. The portable vanity lighting system of claim 52 wherein the securing device comprises adhesive members.

61. The portable vanity lighting system of claim 52 further comprising rechargeable batteries.

62. The portable vanity lighting system of claim 52 further comprising a controller configured to dim the light output of the at least one illuminating member of at least one of the plurality of segments in response to a signal from an actuator.
